(19) United States
(12) Patent Application Publication
(10) Pub. No.: US 2011/0042194 A1
(43) Pub. Date: Feb. 24, 2011

(54) TRANSPARENT KEY, KEY SHEET AND MANUFACTURING METHOD OF KEYSHEET

(75) Inventors: Hideki Yoshikoshi, Niigata (JP); Yasushi Yoshii, Niigata (JP); Minoru Yoshida, Niigata (JP)

Correspondence Address: WESTMAN CHAMPLIN & KELLY, P.A., SUITE 1400, 900 SECOND AVENUE SOUTH, MINNEAPOLIS, MN, 55402, US

(73) Assignee: SUNARROW LIMITED, Tokyo (JP)

(21) Appl. No.: 12/922,962

(22) PCT Filed: Mar. 26, 2009
(86) PCT No.: PCT/JP2009/056114

§ 371 Date: Sep. 16, 2010

(30) Foreign Application Priority Data
Mar. 31, 2008 (JP) 2008-094192

(51) Int. Cl. H01H 13/14; B29C 35/08

(52) U.S. Cl. 200/341; 264/400

(57) ABSTRACT

Disclosed is a transparent key which facilitates position control of a marking portion in the direction of thickness of a key. The transparent key has a transparent key body, a color layer which is formed at a bottom surface of the key body, and is visible through the key body at a time of non-illumination, a first area, and a transparent second area covering the first area from a top surface side. Laser marking is performed more easier for the first area than for the second area.

### BACKGROUND OF THE INVENTION

1. Field of the Invention

The present invention relates to a transparent key and a key sheet, which are used in electronic devices, such as a cell phone (including a so-called PHS (Personal Handy-phone System)), PDA (Personal Digital Assistance), and a keyboard, and a manufacturing method of the key sheet.

2. Description of the Related Art

A transparent key has a transparent key body, and a color layer formed at the bottom surface of the key body. According to the invention, the color layer is visible through the key body at the time of non-illumination. As the transparent key has the color layer visible through the key body, the transparency of the key is expressed, thereby giving good appearance. Accordingly, the transparent key is popular as a key. Even a key having a transparent key body and a color layer formed at the bottom surface of the key body may not be the aforementioned transparent key if the top surface of the key body is covered with a color layer or a metal layer or the like and a display portion with an outline character or the like is formed on this covering layer.

Patent Document 1 (WO2004/068519) discloses, as one example of inventions relevant to such a transparent key, a marking method of marking a character, a symbol or the like inside a key top made of a translucent material by irradiation of a laser beam to the key top, wherein a laser beam of a near infrared light range, a visible light range or a near ultraviolet light range with a wavelength of 1064 nm or shorter is intermittently irradiated, focused on a desired position inside the key top, to form an aggregation of multiple fine carbonized black points or an aggregation of points whitened by fine cracks or foams, which represents a character, a symbol or the like.

According to the marking method disclosed in Patent Document 1, however, the key top (key body) is transparent, so that a laser beam transmits, making it difficult to form carbonized black points.

The present inventor has discovered formation of a key body with a master batch or the like containing a laser-beam absorbent in order to facilitate formation of such carbonized black points. It is however found that while laser marking on such a key body is easier, the top surface of the key body is carbonized and the carbonized black points are exposed to the top surface.

In other words, laser marking on a key body made of a material which is easily laser-marked brings about a problem such that the marking portion formed by the laser marking is exposed to the top surface of the key, thus making it difficult to control the position of the marking portion in the direction of thickness of the key.

Accordingly, it is an object of the present invention to provide a transparent key and a key sheet, which facilitate position control of a marking portion in the direction of thickness of a key, and a manufacturing method of the key sheet.

### SUMMARY OF THE INVENTION

One aspect of a transparent key according to the invention is a transparent key that has a transparent key body, a color layer which is formed at a bottom surface of the key body, and is visible through the key body at a time of non-illumination, a first area, and a transparent second area covering the first area from a top surface side, wherein laser marking for said first area is easier than for said second area.

Illumination herein is to illuminate transparent keys (specifically, a key sheet or the like having transparent keys) from the back side using an internal light source of an electronic device when the transparent keys are incorporated into the electronic device. Non-illumination is not to illuminate transparent keys using the internal light source. At the time of non-illumination, transparent keys are illuminated from the top side by natural light, indoor illumination light or the like. This allows the user of the electronic device to view the color layer.

The second area, which covers the first area from the top surface side, needs to cover at least a part of the first area. Laser marking has only to be carried out by irradiating a laser beam into the first area covered with the second area. An area, such as the first area or the second area, in the invention is a three-dimensional area.

Laser marking according to the invention is a method of forming a marking portion by irradiating a laser beam to a predetermined area. The marking portion expresses, for example, a display portion. The marking portion is formed as at least a part of a character, a symbol, a figure or the like to express the display portion. In this case, the marking portion becomes a component of the display portion. Alternatively, the marking portion is formed around a character, a symbol, a figure or the like to express the display portion in the opposite form to the form of an outline character in case of achieving transparency or discoloring, or in the form of an outline character or the like in case of achieving coloring or the like. The display portion is a character, a symbol, a figure or the like. One transparent key may have a plurality of display portions.

Even if a laser beam with the same condition as a desired laser beam to be used in performing laser marking on the first area is irradiated on the second area, the laser beam transmits the second area completely or almost completely, so that the second area may not be changed at all or may be changed slightly so as not to deteriorate the appearance of the key. In such a case, the first area becomes easier to be laser-marked than the second area.

According to another aspect of the transparent key according to the invention, the key body has the first area and the second area, the first area is a transparent area which is colored by the laser marking, and the transparent key has a marking portion formed of a portion colored by the laser marking.

The transparent area which is colored by the laser marking is basically a laser-beam irradiated portion in the area which is colored. There may be a case where a portion near the irradiated portion is colored, or the irradiated portion and a portion in the vicinity thereof are colored together. The vicinity of the irradiated portion is a portion in another area adjacent to the first area, and includes the vicinity of the boundary between this another area and the first area. That is, the portion (marking portion) colored by irradiation of a laser beam may extend out into another area adjacent to the first area. There may be a case where the marking portion formed by laser marking on the first area is positioned across a part or whole of the interior of the first area, or is positioned across a part or whole of the interior of the first area and a portion in the vicinity thereof, in the direction of thickness of the key body. The portion to be colored may not be continuously present in the area to be marked (e.g., it may not be present so as to fill out the display portion), and may be present in places discontinuously to express the display portion as a whole.

According to a further aspect of the transparent key according to the invention, the first area is formed of a hard resin transparent member containing a laser-beam absorbent, the second area is formed of a hard resin transparent member which does not contain the laser-beam absorbent, and upon absorption of a laser beam for the laser marking, the laser-beam absorbent generates heat to carbonize a surrounding which is caused to be colored in black.

According to a still further aspect of the transparent key according to the invention, the first area is formed of a hard resin transparent member containing a laser-beam triggered coloring material, the second area is formed of a hard resin transparent member which does not contain the laser-beam triggered coloring material, and upon irradiation of a laser beam for the laser marking, the laser-beam triggered coloring material is colored in a color other than black and/or colors a surrounding in a color other than the black.

The “hard resin” in this aspect is a synthetic resin which becomes hard when being cured.

According to a still further aspect of the transparent key according to the invention, the color layer has the first area, the key body has the second area, the first area is a area which is made transparent or is discolored by the laser marking, and the transparent key has a marking portion formed of a portion which is made transparent or is discolored by the laser marking.

The transparent area which is made transparent or discolored by the laser marking is basically a laser-beam irradiated portion in the area which is made transparent or discolored. There may be a case where a portion near the irradiated portion is made transparent or discolored, or the irradiated portion and a portion in the vicinity thereof are made transparent or discolored together. The vicinity of the irradiated portion is a portion in another area adjacent to the first area, and includes the vicinity of the boundary between this another area and the first area. That is, the portion (marking portion) which is made transparent or discolored by irradiation of a laser beam may extend out into another area adjacent to the first area. There may be a case where the marking portion formed by laser marking on the first area is positioned across a part or whole of the interior of the first area, or is positioned across a part or whole of the interior of the first area and a portion in the vicinity thereof, in the direction of thickness of the key body. The portion to be made transparent or discolored may not be continuously present in the area to be marked (e.g., it may not be present so as to fill out the display portion), and may be present in places discontinuously to express the display portion as a whole. It is desirable to form a marking portion having a large portion which is made transparent or discolored in a translucent color so that the marking area can have translucency as a whole.

One aspect of a key sheet according to the invention is a key sheet having any one of the transparent key described above.

One aspect of a manufacturing method of a transparent key according to the invention is a method of forming a transparent key having a transparent key body, a color layer which is formed at a bottom surface of the key body, and is visible through the key body at a time of non-illumination, and a key base having the transparent key laid out thereon, the transparent key having a first area and a transparent second area covering the first area from a top surface side, the first area being easier to be subjected to laser marking than the second area, the laser marking being carried out after the transparent key is laid out on the key base.

According to the key sheet, the transparent keys and the key base may be made integral. In this case, some of the components of the transparent key may constitute a part of the key base. Even in this case, it is expressed that transparent keys are laid out on the key base in forming the key sheet. One example of such a key sheet is a sheet-like key sheet. In this case, predetermined areas of the key sheet which is operable, such as depression, are expressed as transparent keys.

“Color” in the invention includes white, black, and so forth. “Transparency” in the invention includes colorless transparency as well as colored transparency.

### EFFECT OF THE INVENTION

In case of performing laser marking on a transparent key, the laser marking is normally performed from the top surface side because a color layer is present at the bottom surface side. According to the invention, the transparent key has a first area and a transparent second area covering the first area from the top surface side, and the first area is laser-marked more easily than the second area. Since it is harder to perform laser marking on the second area than on the first area, there is no or a little influence of the laser marking on the second area. Therefore, the position of the marking portion in the direction of thickness of the key, which is formed by the laser marking, depends on the first area. The position of the marking portion in the direction of thickness of the key can easily be decided by changing the condition, such as the structure of the transparent key or the thickness of the second area. As apparent from the above, the transparent key, the key sheet, and the manufacturing method of the key sheet according to the invention make it easier to control the position of the marking portion in the direction of thickness of the key.

### BRIEF DESCRIPTION OF THE DRAWINGS

FIG. 1 is a schematic cross-sectional view of one example of a key sheet according to a first embodiment of the invention;

FIG. 2 is a schematic cross-sectional view of one example of a key sheet according to a second embodiment of the invention;

FIG. 3 is a schematic cross-sectional view of one example of a key sheet according to a third embodiment of the invention;

FIG. 4 is a schematic cross-sectional view of one example of a key sheet according to a fourth embodiment of the invention;

FIG. 5 is a schematic cross-sectional view of one example of a key sheet according to a fifth embodiment of the invention;

FIG. 6 is a schematic cross-sectional view of one example of a key sheet according to a sixth embodiment of the invention;

FIG. 7 is a schematic cross-sectional view of one example of a key sheet according to a seventh embodiment of the invention;

FIG. 8 is a schematic cross-sectional view of one example of a key sheet according to an eighth embodiment of the invention;

FIG. 9 is a drawing showing one example of a manufacturing method of a key sheet according to the invention;

FIG. 10 is a perspective view of one example of the key sheet according to the ninth embodiment of the invention;

FIG. 11 is a perspective view of one example of the key sheet according to the ninth embodiment of the invention;

FIG. 12 is a perspective view of a cell phone in which one example of the key sheet according to the ninth embodiment of the invention is mounted; and

FIG. 13 is a perspective view of another example of the key sheet according to the ninth embodiment of the invention.

### DETAILED DESCRIPTION OF EMBODIMENTS

Embodiments of the present invention are described below referring to the accompanying drawings. Same reference numerals may be given to identical or corresponding components or those components which can be termed generally throughout the drawings. There is a case where a same reference numeral may be given to a plurality of components which are identical or corresponding to one another or which can be termed generally throughout the drawings. The invention is not limited to the following embodiments alone. It is to be noted that the following embodiments may be subject to modifications (such as omission or addition of a constituting element (member or the like), and change in the shape of a constituting element) without departing from the spirit or scope of the invention. It is desirable that the total thickness of a transparent key should be 0.2 mm or greater in the following embodiments. It is desirable that the thicknesses of a first area and a second area should not be 0.03 mm or less unless otherwise specified, and should particularly be 0.05 mm or greater. A protection layer or the like to protect a transparent key itself may be provided at the top surface or the like of the key body of a transparent key according to the invention though not mentioned in the following description of the embodiments.

### (1) First Embodiment

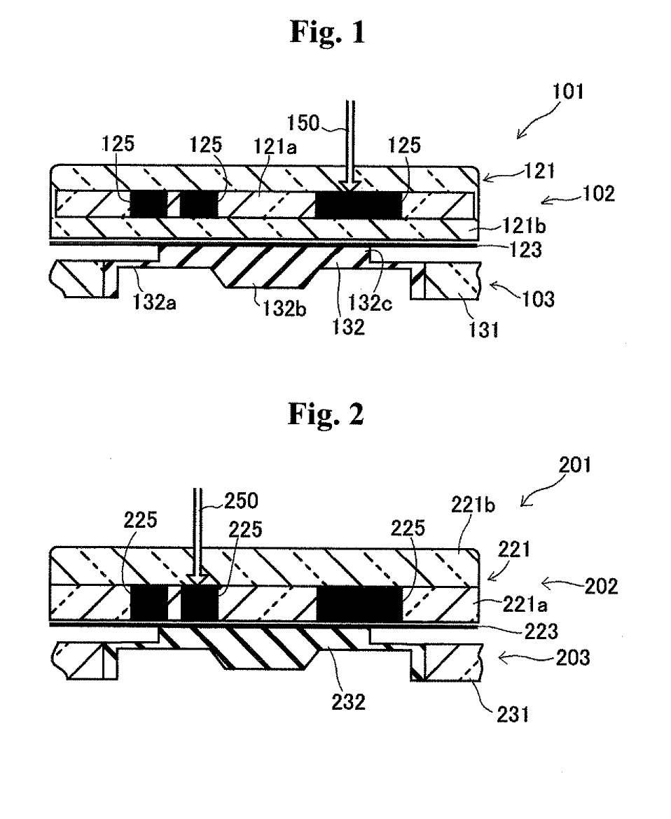

As shown in FIG. 1, a key sheet 101 has one or more transparent keys 102, and a key base 103 on which the one or more transparent keys 102 are laid out.

The transparent key 102 has a transparent key body 121 and a color layer 123 formed at the bottom surface of the key body 121. At the time of non-illumination, the color layer 123 is visible through the key body 121 in the transparent key 102. In FIG. 1, the color layer 123 is illustrated apart from the key body 121 to make it easier to show the presence of the color layer 123. As the color layer 123 is formed at the bottom surface of the key body 121, however, the color layer 123 and the key body 121 are adjacent to each other.

The transparent key 102 has a first area 121a, and second areas 121b covering the first area 121a from the top surface side. The key body 121 has the first area 121a and the second areas 121b. The key body 121 has a sandwich structure where the first area 121a is held between the second areas 121b. That is, the key body 121 has a three-layer structure comprising the second area 121b, the first area 121a and the second area 121b. The key body 121 is formed by ejection molding or the like which supplies two kinds of materials are supplied into a mold. The second area 121b present on the color layer 123 side may be provided as another area.

The first area 121a is an area where laser marking can be performed more easily than the second area 121b. The first area 121a is a transparent area which is colored by laser marking, and is colored by irradiation of a laser beam 150 to be used in laser marking. Even if a laser beam 150 with the same condition as the aforementioned laser beam 150 is irradiated to the second area 121b, the laser beam 150 transmits the second area 121b completely or almost completely, so that the second area 121b is not changed (e.g., colored) at all or is changed slightly so as not to deteriorate the appearance of the key.

The transparent key 102 has a marking portion 125 which is formed by the portion that is colored by laser marking. When the laser beam 150 is irradiated to the first area 121a from the top surface side of the transparent key 102, the irradiated portion in the first area 121a is colored, but there may be a case where a portion near the irradiated portion is colored, or the irradiated portion and a portion in the vicinity thereof are colored together. In irradiating the laser beam 150 to the first area 121a, the laser beam 150 should be focused onto the first area 121a in the direction of thickness of the key. The vicinity of the irradiated portion is a portion in another area (second area 121b in this example) adjacent to the first area 121a, and includes the vicinity of the boundary between this another area and the first area 121a. In FIG. 1, the marking portion 125 falls within the first area 121a in the direction of thickness of the key, and extends over the entire interior of the first area 121a. However, there may be a case where the marking portion 125 may extend out into another area (second area 121b in this example) adjacent to the first area 121a. The marking portion 125 may be formed at a part of the interior of the first area 121a in the direction of thickness of the key. In either case, the first area 121a has the marking portion 125 which is formed around the first area 121a.

The first area 121a is, for example, a transparent laser-beam absorbent area. When the laser beam 150 is irradiated to the laser-beam absorbent area, the irradiated portion (focused point) of the laser beam 150 and/or a portion in the vicinity thereof absorb the laser beam 150 and generate heat to be carbonized. The laser-beam absorbent area is formed of, for example, a transparent master batch, such as a first hard resin transparent material containing a laser-beam absorbent (color former). The laser-beam absorbent is fine powder, e.g., a laser-beam absorbent pigment or the like. Upon absorption of the laser beam 150, the laser-beam absorbent generates heat to carbonize a surrounding, thereby coloring it in black. The laser-beam absorbent before irradiation of the laser beam 150 is too fine to be confirmed by naked eyes, so that the first area 121a containing the laser-beam absorbent (even though transparent it is) may have the transparency lowered as compared with a case where the first area 121a does not contain the laser-beam absorbent.

The first area 121a may be, for example, a transparent laser-beam triggered coloring area which is colored in a color other than black by the carbonization. When the laser beam 150 is irradiated to the laser-beam triggered coloring area, the irradiated portion of the laser beam 150 and/or a portion in the vicinity thereof are colored due to foaming, condensation, chemical change or the like. The laser-beam triggered coloring area is formed by, for example, a transparent master batch, such as a third hard resin transparent material containing a laser-beam triggered coloring material (color former). The laser-beam triggered coloring material is colored itself in a color other than black provided by carbonization, and/or it colors the surrounding of the coloring material (in a color other than black). When the laser-beam triggered coloring material is irradiated with the laser beam, for example, it is gasified to be foamed and colored, and/or it absorbs the laser beam to gasify the surrounding of the laser-beam triggered coloring material, thereby causing the surrounding to be foamed and colored. When the laser-beam triggered coloring material is irradiated with the laser beam, for example, it absorbs the laser beam and increases its molecular density, thereby being condensed and colored. The laser-beam triggered coloring material contains metal ions, for example, so that when irradiated with the laser beam, the crystal structure of the ions changes and/or the amount of hydration changes. This causes a chemical change in the compositions or the like of the components of the laser-beam triggered coloring material, thereby making it concentrated and colored. The laser-beam triggered coloring material is fine powder, e.g., a laser-beam triggered coloring pigment or the like. The laser-beam triggered coloring material before irradiation of the laser beam 150 is transparent or too fine to be confirmed by naked eyes, so that the first area 121a containing this material may become transparent, while its transparency may be lowered in some case.

At this time, the second area 121b is a laser-beam transmitting area which allows the laser beam 150 to transmit completely or almost completely. The laser-beam transmitting area is formed of a second hard resin transparent material which does not contain the laser-beam absorbent or the like, or a fourth hard resin transparent material which does not contain the laser-beam triggered coloring material.

The color layer 123 includes one or more layers, such as a coat formed by printing, coating or the like. The color layer 123 has a display portion as needed. The display portion is a basic display portion which does not depend on the language used in a country where electronic devices in which the key sheet 101 is incorporated are to be sold. The basic display portion has a character (e.g., Arabic numeral), a symbol, or a figure which does not depend on the used language.

As the hard resin, an electromagnetic curing resin, such as an acrylic resin, epoxy resin, vinyl resin or a silicone resin, can be used. Electromagnetic curing resins are resins which are cured when irradiated with electromagnetic waves, and include ultraviolet-ray curing resin (UV curing resin) and a visible-ray curing resin. As the hard resin, a synthetic resin, such as a PET (Polyethylene Terephthalate) resin, PC (Polycarbonate) resin, polyurethane resin, acrylic resin or silicone resin, can also be used as a general thermoplastic resin or thermosetting resin. Those hard resins have translucency when cured. That is, the hard resins become transparent.

The laser beam 150 is, for example, oscillated by a YAG laser with a wavelength of 1064 nm. With regard to the conditions, such as the output and the spot size, the output is several watts to several tens of watts, and the spot size is 20 to 150 μm. The wavelength of the laser beam 150 may be 532 nm. The oscillation mechanism or the like for the laser beam 150 may employ a publicly known art as needed. In laser marking, the oscillation section for the laser beam 150 is moved to make marking on a transparent key, the mechanism or the like which moves the oscillation section can employ a publicly known art as needed.

The key base 103 has a reinforced plate 131 having a through hole formed in correspondence to each of one or more transparent keys 102, and a deformation portion (pad portion) 132 which is formed so as to close the through hole and is deformable. The reinforced plate 131 serves to add the rigidity to the entire key base 103, and is formed of a hard resin or by a metal plate. Although the aforementioned resins can be used as the hard resin, there is a case where translucency is not necessary. The deformation portion 132 is formed of a deformable material, such as an elastic material, to make the downward movement of the transparent key 102 smoother. As the elastic material, a synthetic resin or the like having elasticity is used. The synthetic resin is a rubber, thermoplastic elastomer or the like. An example of the rubber member is a silicone rubber. There may be a case where the deformation portion 132 does not need translucency.

The deformation portion 132 has a thin portion 132a, a pressing element 132b formed at the bottom surface of the thin portion 132a, and a seating 132c formed at the top surface of the thin portion 132a. The pressing element 132b serves to press a switch element, such as an opposing metal dome or the like when the key sheet 101 is mounted in an electronic device. The seating 132c is provided to keep the stroke needed for the downward movement of the transparent key 102. The transparent key 102 is arranged on the top surface of the seating 132c. Specifically, the transparent key 102 is secured to the top surface of the seating 132c by a translucent adhesive or the like.

### (2) Second Embodiment

As shown in FIGS. 1 and 2, there is difference in the structure of the key body between the key sheet 101 according to the first embodiment and a key sheet 201 according to a second embodiment. A key body 221 has a double-layer structure including a first area 221a and a second area 221b.

As the other points conform to the description of the first embodiment, their descriptions are omitted. The first area 221a corresponds to the first area 121a, and the second area 221b corresponds to the second area 121b. A color layer 223 corresponds to the color layer 123. A key base 203 corresponds to the key base 103. A reinforced plate 231 corresponds to the reinforced plate 131. A deformation portion 232 corresponds to the deformation portion 132. A marking portion 225 corresponds to the marking portion 125. A laser beam 250 corresponds to the laser beam 150.

### (3) Third Embodiment

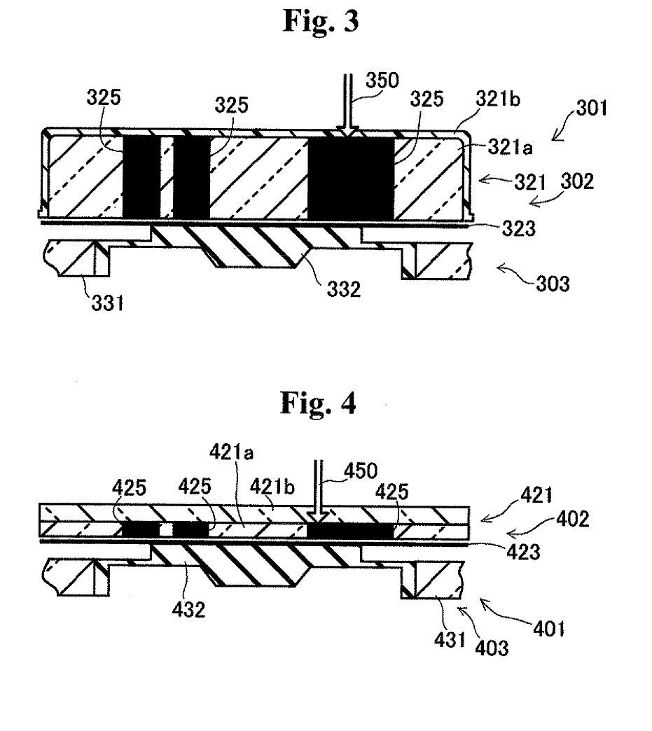

As shown in FIGS. 1 and 3, there is difference in the structure of the key body between the key sheet 101 according to the first embodiment and a key sheet 201 according to a third embodiment. A key body 321 has a structure where a first area 321a is covered with a film-like second area 321b. The key body 321 is made by forming the film-like second area 321b of 0.5 mm or less in thickness so as to have a recessed portion and filling the first area 321a in the recessed portion.

As the other points conform to the description of the first embodiment, their descriptions are omitted. The first area 321a corresponds to the first area 121a, and the second area 321b corresponds to the second area 121b. A color layer 323 corresponds to the color layer 123. A key base 303 corresponds to the key base 103. A reinforced plate 331 corresponds to the reinforced plate 131. A deformation portion 332 corresponds to the deformation portion 132. A marking portion 325 corresponds to the marking portion 125. A laser beam 350 corresponds to the laser beam 150.

### (4) Fourth Embodiment

As shown in FIGS. 1 and 4, there is difference in the structure of the key body between the key sheet 101 according to the first embodiment and a key sheet 401 according to a fourth embodiment. A key body 421 has a double-layer structure including a film-like first area 421a and a film-like second area 421b. The first area 421a and the second area 421b are securely adhered by a transparent adhesive, or a transparent sticker, welding or the like.

As the other points conform to the description of the first embodiment, their descriptions are omitted. The first area 421a corresponds to the first area 121a, and the second area 421b corresponds to the second area 121b. A color layer 423 corresponds to the color layer 123. A key base 403 corresponds to the key base 103. A reinforced plate 431 corresponds to the reinforced plate 131. A deformation portion 432 corresponds to the deformation portion 132. A marking portion 425 corresponds to the marking portion 125. A laser beam 450 corresponds to the laser beam 150.

### (5) Fifth Embodiment

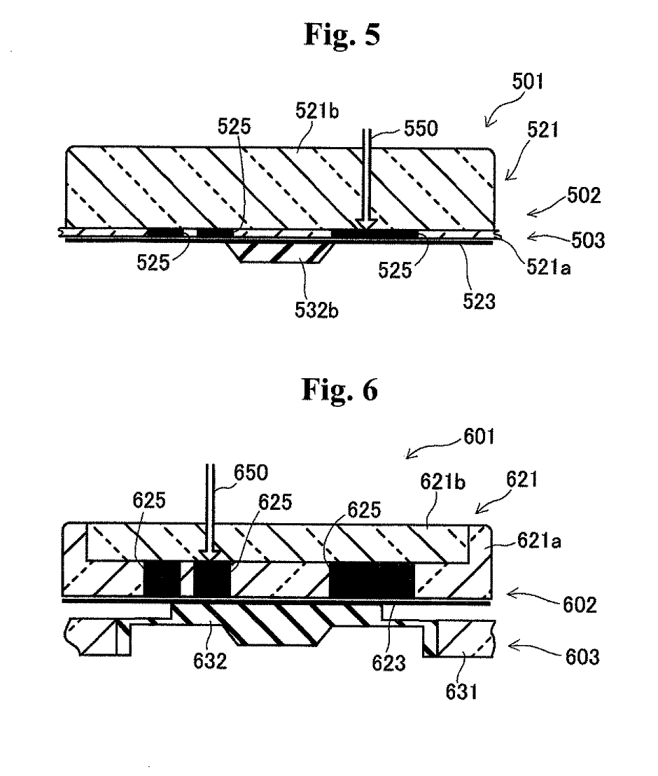

As shown in FIGS. 1 and 5, there is difference in the structure of the key body between the key sheet 101 according to the first embodiment and a key sheet 501 according to a fifth embodiment. The key sheet 501 has a transparent key 502 and a key base 503 integrated. The key sheet 501 has a film-like first area 521a of 0.5 mm or less in thickness, one or more second areas 521b formed on the top surface of the first area 521a, one or more color layers 523 respectively corresponding to the one or more second areas 521b and formed at the bottom surfaces of the one or more second areas 521b, and a pressing element 532b formed at the bottom surface of the color layer 523. The second area 521b and the pressing element 532b are formed by gravure printing or the like. The transparent key 502 has the first area 521a, that portion of the second area 521b which corresponds to the first area 521a, and the color layer 523. The key base 503 has the second area 521b, the color layer 523 and the pressing element 532b.

As the other points conform to the description of the first embodiment, their descriptions are omitted. The first area 521a corresponds to the first area 121a, and the second area 521b corresponds to the second area 121b. A color layer 523 corresponds to the color layer 123. A key base 503 corresponds to the key base 103. A marking portion 525 corresponds to the marking portion 125. A laser beam 550 corresponds to the laser beam 150. The pressing element 532b corresponds to the pressing element 132b. (It is to be noted that the pressing element 532b may be formed of the aforementioned hard resins or the like.)

### (6) Sixth Embodiment

As shown in FIGS. 1 and 6, there is difference in the structure of the key body between the key sheet 101 according to the first embodiment and a key sheet 601 according to a sixth embodiment in the structure of the key body. A key body 621 has a double-layer structure including a first area 621a and a second area 621b. The second area 621b covers a part of the first area 621a from the top surface side. A laser beam is irradiated into the first area 621a covered with the second area 621b to effect laser marking. The key body 621 is formed by filling the second area 621b into the first area 621a having a recessed portion.

As the other points conform to the description of the first embodiment, their descriptions are omitted. The first area 621a corresponds to the first area 121a, and the second area 621b corresponds to the second area 121b. A color layer 623 corresponds to the color layer 123. A key base 603 corresponds to the key base 103. A reinforced plate 631 corresponds to the reinforced plate 131. A deformation portion 632 corresponds to the deformation portion 132. A marking portion 625 corresponds to the marking portion 125. A laser beam 650 corresponds to the laser beam 150.

### (7) Seventh Embodiment

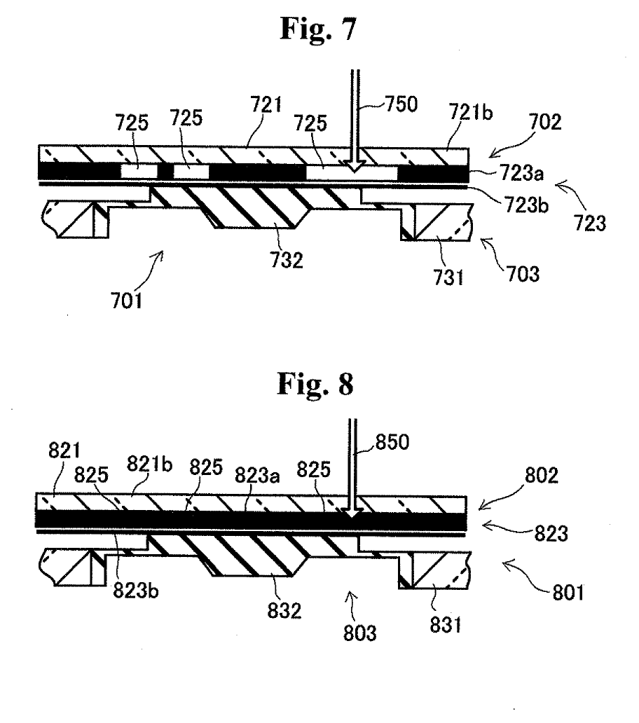

As shown in FIGS. 1 and 7, there is difference in the structure of the key body between the key sheet 101 according to the first embodiment and a key sheet 701 according to a seventh embodiment in the structure of the key body. A transparent key 702 has a key body 721 and a color layer 723 formed at the bottom surface of the key body 721. The color layer 723 has a first area 723a and a bottom-side color layer 723b formed at the bottom surface of the first area 723a. The key body 721 has the second area 721b. The first area 723a is a colored layer which is to be made transparent by laser marking. The first area 723a and the color layer 723b are formed by, for example, printing or the like. The bottom-side color layer 723b is formed of a single layer or a lamination of a plurality of layers.

The transparent key 702 has a marking portion 725 which is formed of the portion that is made transparent by laser marking. When the laser beam 750 is irradiated to the first area 721a from the top surface side of the transparent key 702, the irradiated portion in the first area 721a is made transparent, but there may be a case where a portion near the irradiated portion is made transparent, or the irradiated portion and a portion in the vicinity thereof are made transparent together. In irradiating the laser beam 750 to the first area 721a, the laser beam 750 should be focused onto the first area 721a in the direction of thickness of the key. The vicinity of the irradiated portion is a portion in another area (second area 721b or the like in this example) adjacent to the first area 721a, and includes the vicinity of the boundary between this another area and the first area 721a. In FIG. 7, the marking portion 725 falls within the first area 721a in the direction of thickness of the key, and extends over the entire interior of the first area 721a. However, there may be a case where the marking portion 725 may extend out into another area (second area 721b or the like in this example) adjacent to the first area 721a. The marking portion 725 may be formed at a part of the interior of the first area 721a in the direction of thickness of the key. In either case, the first area 721a has the marking portion 725 which is formed around the first area 721a.

The first area 723a is, for example, a laser-beam triggered transparent area. When the laser beam 750 is irradiated to the laser-beam triggered transparent area, the portion irradiated with the laser beam 750 and/or a portion in the vicinity thereof are made transparent by gasification, chemical change or the like. The laser-beam triggered transparent area is formed of, for example, a color master batch, such as a hard resin color material containing a laser-beam triggered transparent material which is made transparent when irradiated with the laser beam. When irradiated with the laser beam, for example, the laser-beam triggered transparent material is gasified to become transparent and/or, it gasify the surrounding of the laser-beam triggered transparent material to make the surrounding transparent. The laser-beam triggered transparent material is made transparent because the compositions or the like of the laser-beam triggered transparent material are chemically changed. The laser-beam triggered transparent material is a fine powder, i.e., a laser-beam triggered transparent pigment.

At this time, the second area 721b is a transparent laser-beam transmitting area which completely or almost completely transmits the laser beam 750.

As the other points conform to the description of the first embodiment, their descriptions are omitted. The second area 721b corresponds to the second area 121b. The color layer 723b corresponds to the color layer 123. A key base 703 corresponds to the key base 103. A marking portion 725 corresponds to the marking portion 125. A reinforced plate 731 corresponds to the reinforced plate 131. A deformation portion 732 corresponds to the deformation portion 132. The laser beam 750 corresponds to the laser beam 150.

### (8) Eighth Embodiment

As shown in FIGS. 1 and 8, there is difference in the structure of the key body between the key sheet 101 according to the first embodiment and a key sheet 801 according to an eighth embodiment. A transparent key 802 has a key body 821 and a color layer 823 formed at the bottom surface of the key body 821. The color layer 823 has a first area 823a and a bottom-side color layer 823b formed at the bottom surface of the first area 823a. The key body 821 has the second area 821b. The first area 823a is a colored layer which is to be discolored by laser marking. The first area 823a and the color layer 823b are formed by, for example, printing or the like. The bottom-side color layer 823b is formed of a single layer or a lamination of a plurality of layers.

The transparent key 802 has a marking portion 825 which is formed of the portion that is discolored by laser marking. When the laser beam 850 is irradiated to the first area 821a from the top surface side of the transparent key 802, the irradiated portion in the first area 821a is discolored, but there may be a case where a portion near the irradiated portion is discolored, or the irradiated portion and a portion in the vicinity thereof are discolored together. In irradiating the laser beam 850 to the first area 821a, the laser beam 850 should be focused onto the first area 821a in the direction of thickness of the key. The vicinity of the irradiated portion is a portion in another area (second area 821b or the like in this example) adjacent to the first area 821a, and includes the vicinity of the boundary between this another area and the first area 821a. In FIG. 8, the marking portion 825 falls within the first area 821a in the direction of thickness of the key, and extends over the entire interior of the first area 821a. However, there may be a case where the marking portion 825 may extend out into another area (second area 821b or the like in this example) adjacent to the first area 821a. The marking portion 825 may be formed at a part of the interior of the first area 821a in the direction of thickness of the key. In either case, the first area 821a has the marking portion 825 which is formed around the first area 821a. The first area 823a may be formed thin so that the marking portion 825 has translucency and the entire marked area has translucency.

The first area 823a is, for example, a laser-beam triggered discolored area. When the laser beam 850 is irradiated to the laser-beam triggered discolored area, the portion irradiated with the laser beam 850 and/or a portion in the vicinity thereof absorbs the laser beam 850 to generate heat and is discolored. The first area 823a is formed of, for example, a material containing a color substance (fine powdery substance) of the desired color to be made. In this case, the black portion absorbs the laser beam to generate heat and is gasified by the heat to become transparent, while the color substance remains so that the first area 823a is colored by the color of the color substance.

The first area 823a may be another laser-beam triggered discoloring area. When the laser beam 850 is irradiated to the laser-beam triggered discoloring area, the irradiated portion of the laser beam 850 and/or a portion in the vicinity thereof are discolored due to foaming, condensation, chemical change or the like. The laser-beam triggered discoloring area is formed of, for example, a color master batch, such as a hard resin color material containing a laser-beam triggered discoloring material (color former). When the laser-beam triggered discoloring material is irradiated with the laser beam, for example, it is gasified to be foamed and discolored, and/or it absorbs the laser beam to gasify the surrounding of the laser-beam triggered coloring material, thereby causing the surrounding to be foamed and discolored. When the laser-beam triggered discoloring material is irradiated with the laser beam, for example, it absorbs the laser beam, increasing its molecular density, which causes the laser-beam triggered coloring material to be condensed and colored. The laser-beam triggered discoloring material contains metal ions, for example, so that when irradiated with the laser beam, the crystal structure of the ions changes and/or the amount of hydration changes. This causes a chemical change in the compositions or the like of the components of the laser-beam triggered discoloring material, so that concentration of the laser-beam triggered discoloring material is increased and it is discolored. The laser-beam triggered discoloring material is fine powder, e.g., a laser-beam triggered discoloring pigment or the like. The laser-beam triggered discoloring material before irradiation of the laser beam 850 is transparent or too fine to be confirmed by naked eyes, so that the first area 821a containing this material may become transparent, while its transparency may be lowered in some case. The first area 823a may be formed thin so that the marking portion 825 has translucency.

At this time, the second area 821b is a transparent laser-beam transmitting area which completely or almost completely transmits the laser beam 850.

As the other points conform to the description of the first embodiment, their descriptions are omitted. The second area 821b corresponds to the second area 121b. The color layer 823b corresponds to the color layer 123. A key base 803 corresponds to the key base 103. A marking portion 825 corresponds to the marking portion 125. A reinforced plate 831 corresponds to the reinforced plate 131. A deformation portion 832 corresponds to the deformation portion 132. The laser beam 850 corresponds to the laser beam 150.

### (9) Outlines of First to Eighth Embodiments

In the first to eighth embodiments, the transparent key has the first area and the transparent second area covering the first area from the top surface side, and the first area is laser-marked more easily than the second area. Since it is harder to perform laser marking on the second area than on the first area, there is no or a little influence of the laser marking on the second area. Therefore, the position of the marking portion in the direction of thickness of the key, which is formed by the laser marking, depends on the first area. The position of the marking portion in the direction of thickness of the key can easily be decided by changing the condition, such as the structure of the transparent key or the thickness of the second area. As apparent from the above, the transparent keys and the key sheets according to the first to eighth embodiments make it easier to control the position of the marking portion in the direction of thickness of the key.

According to the first to sixth embodiments, the key body has the first area and the second area, the first area is a transparent area to be colored by laser marking, and the transparent key has the marking portion formed by the portion colored by the laser marking. According to the transparent keys and the key sheets according to the first to sixth embodiments, therefore, the position of the marking portion can be controlled in the key body. It is therefore possible to provide the transparent key and key sheet with new appearances.

Further, the first area is formed of the first hard resin transparent material containing a laser-beam absorbent, the second area is formed of the second hard resin transparent material which does not contain the laser-beam absorbent, and the laser-beam absorbent absorbs the laser beam for laser marking to generate heat, causing the surrounding to be carbonized and colored in black. Alternatively, the first area is formed of the third hard resin transparent material containing a laser-beam triggered coloring material, the second area is formed of the fourth hard resin transparent material which does not contain the laser-beam triggered coloring material, and when irradiated with the laser beam for laser marking, the laser-beam triggered coloring material is colored in a color other than the black color provided by the carbonization and/or causes the surrounding to be colored in a color other than the black color provided by the carbonization. Those make it possible to easily form a marking portion.

According to the first embodiment, since the key body 121 has a three-layer structure, it is possible to reduce the influence of laser marking on the first area 121a on the color layer 123. Particularly, the presence of the area (second area 121b in this example) between the first area 121a and the color layer 123 can prevent or reduce transmission of heat generated in the first area 121a to the color layer 123.

According to the second embodiment, the key body 221 has a double-layer structure, thus making it easier to flatten the transparent key. In addition, the first area 221a can be positioned on the bottom side, so that the marking portion 225 can be formed on the bottom side.

According to the third embodiment, the key body 321 has a structure such that the film-like second area 321b covers the first area 321a, so that the first area 321a can be made thicker. This makes it possible to prevent the laser beam 350 from reaching the color layer 323 or reduce the amount of the laser beam 350 that reaches the color layer 323.

According to the fourth embodiment, the key body 421 has a double-layer structure having the film-like first area 421a and the film-like second area 421b, thus making it easier to flatten the transparent key. Particularly, the first area 421a is made thinner, which is effective in a case where the degree of transparency of the first area 421a drops.

According to the fifth embodiment, the key sheet 501 has the transparent key 502 and the key base 503 integrated. Since the first area 521a has a film-like shape, it is possible to make the first area 521a thinner and the second area 521b thicker. This can provide a larger transparent area, thus making it possible to keep the transparency of the transparent key in a case where the degree of transparency of the first area 521a drops.

According to the sixth embodiment, the key body 621 has a double-layer structure, thus making it easier to flatten the transparent key. In addition, the first area 621a can be positioned on the bottom side, so that the marking portion 625 can be formed on the bottom side.

According to the seventh embodiment, the color layer 723 has the first area 723a, the key body 721 has the second area 721b, the first area 723a is the area that is made transparent by laser marking, and the transparent key 702 has the marking portion 725 formed by the portion that is made transparent or colored by the laser marking. This can allow the marking portion 725 to be formed at the bottom surface of the transparent key 702. In addition, the display portion can be expressed by an outline character or the like. Further, the contrast between the first area 723a and the bottom-side color layer 723b can provide the transparent key 702 and key sheet 701 with new appearances.

According to the eighth embodiment, the color layer 823 has the first area 823a, the key body 821 has the second area 821b, the first area 823a is the area that is made transparent by laser marking, and the transparent key 802 has the marking portion 825 formed by the portion that is made transparent or colored by the laser marking. This can allow the marking portion 825 to be formed at the bottom surface of the transparent key 802. In addition, the display portion can be expressed by an outline character or the like. Further, the contrast between the first area 823a and the marking portion 825 can provide the transparent key 802 and key sheet 801 with new appearances. Providing the marking portion 825 with translucency makes it possible to form a display portion with a new appearance, and the mixture of the color of the marking portion 825 and the color of the bottom-side color layer 823b makes it possible to form a display portion with a new appearance.

### (10) Ninth Embodiment

The description of a ninth embodiment, which is a manufacturing method of a key sheet is given. The key sheet is described hereinafter as one similar to the key sheet 101 according to the first embodiment.

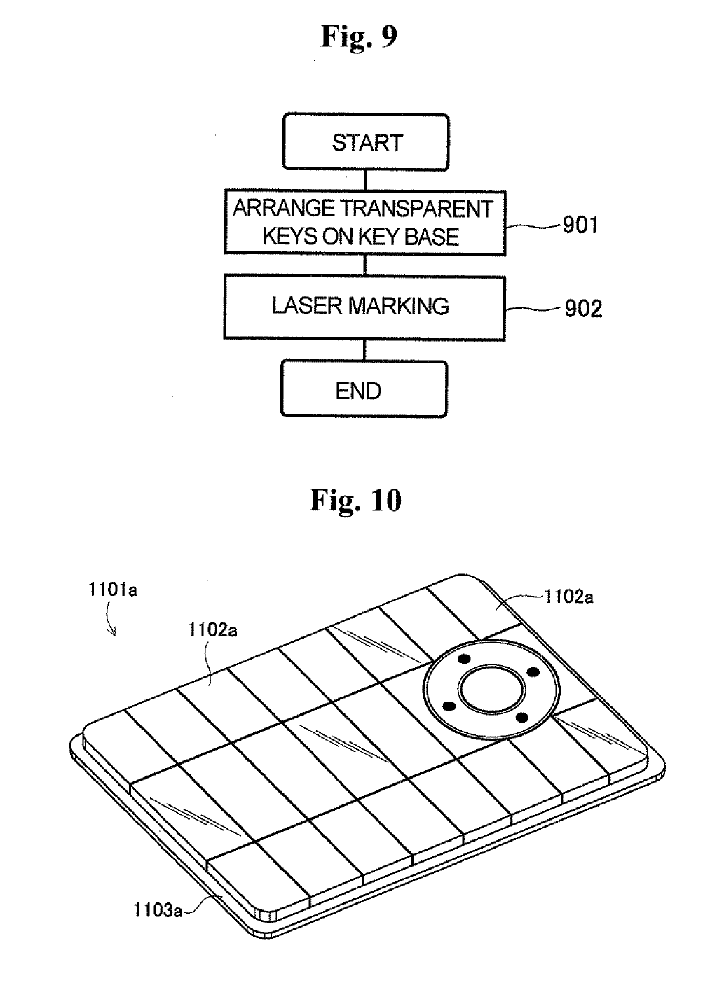

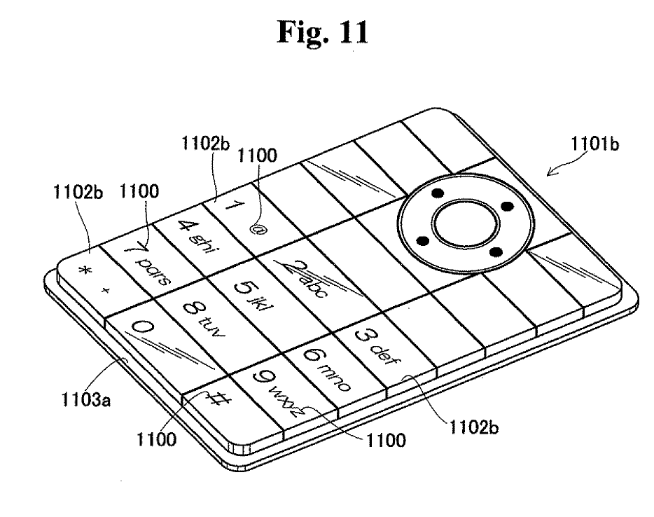

At first, transparent keys 1102a are laid out on a key base 1103a (refer to step 901 in FIG. 9). That is, a key sheet 1101 is formed beforehand before it is laser marked (refer to FIG. 10).

Thereafter, laser marking is performed on the transparent keys 1102a (refer to step 902 in FIG. 9). Then, a display portion 1100 is formed of a marking portion which is formed by the laser marking. The display portion 1100 expresses a key function or the like. The display portion 1100 shows a character, a symbol, a figure or the like. The transparent key 1102b after laser marking has a plurality of display portions 1100 each having a numeral, a symbol, or an alphabet or the like.

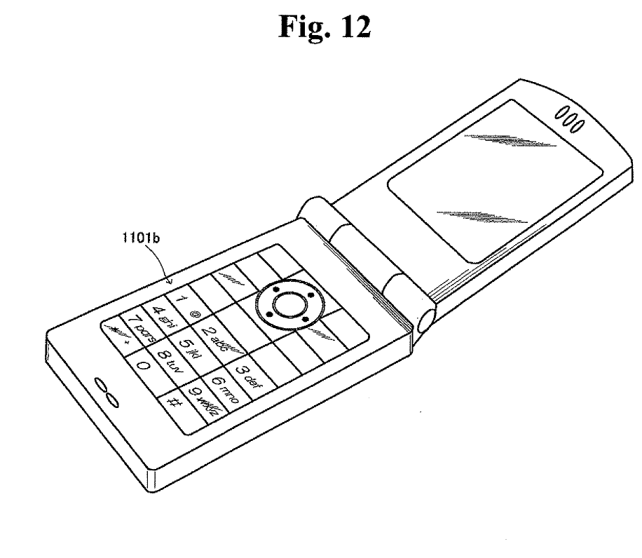

The display portion of the key sheet may depend on the language used in a country where an electronic device having the key sheet mounted therein (refer to FIG. 12; reference numeral “1101b” denoting the key sheet). The conventional transparent key should have a display portion formed at a color layer. This requires that the transparent keys should be laid out on the key base after the used language is decided, which may result in a case where electronic devices having the key sheet mounted therein are not prepared before shipment. If sufficient quantities of necessary types of key sheets according to probable used languages are produced, however, the key sheets may be stored in stock unnecessarily. Apparently, it is difficult to manage the inventory of key sheets having transparent keys.

Accordingly, laser marking is carried out after the transparent keys 1102a not subjected to laser marking are laid out on the key base 1103a. As the key sheet 1101a not subjected to laser marking is prepared beforehand, and the display portion 1100 can be formed after the used language is decided, it is possible to shorten the period from the decision of the used language to the shipment of the key sheet 1101b. This facilitates the inventory control for key sheets.

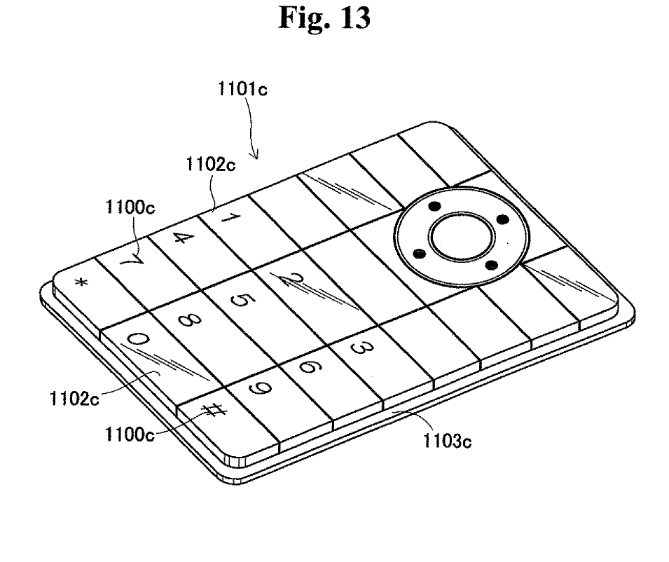

The display portion 1100 has a basic display portion which does not depend on a used language, such as numerals, and a used-language dependent display portion which depends on the used language. In the step 901, transparent keys 1102c each having a basic display portion 1100c formed at the color layer may be arranged on a key base 1103c (refer to FIG. 13). In this case, the time needed for laser marking can be shortened, thus making it possible to further shorten the period from the decision of the used language to the shipment of the key sheet.

### DESCRIPTION OF REFERENCE NUMERALS

101, 201, 301, 401, 501, 601, 701, 801, 1101a, 1101b, 1101c key sheet
102, 202, 302, 402, 502, 602, 702, 802, 1102a, 1102b, 1102c transparent key
103, 203, 303, 403, 503, 603, 703, 803, 1103a, 1103c key base
121, 221, 321, 421, 521, 621, 721, 821 key body
123, 223, 323, 423, 523, 623, 723, 823 color layer
131, 231, 331, 431, 631, 731, 831 reinforced plate
132, 232, 332, 432, 632, 732, 832 deformation portion
121a, 221a, 321a, 421a, 521a, 621a, 723a, 823a first area
121b, 221b, 321b, 421b, 521b, 621b, 721b, 821b second area
723b, 823b bottom-side color layer
125, 225, 325, 425, 525, 625, 725, 825 marking portion
150, 250, 350, 450, 550, 650, 750, 850 laser beam
1100 display portion
1100c basic display portion

1. A transparent key having:
a transparent key body;
a color layer which is formed at a bottom surface of said key body, said color layer which is visible through said key body at a time of non-illumination;
a first area; and
a transparent second area covering said first area from a top surface side,
wherein laser marking is easier for said first area than for said second area.

2. The transparent key according to claim 1, wherein
said key body has said first area and said second area,
said first area is a transparent area which is colored by the laser marking, and
said transparent key has a marking portion formed of a portion colored by said laser marking.

3. The transparent key according to claim 1, wherein
said first area is formed of a hard resin transparent member containing a laser-beam absorbent,
said second area is formed of a hard resin transparent member which does not contain the laser-beam absorbent, and
said laser-beam absorbent generates heat upon absorption of a laser beam used for said laser marking, and carbonizes a surrounding, thereby coloring said surrounding in black.

4. The transparent key according to claim 1, wherein
said first area is formed of a hard resin transparent member containing a laser-beam triggered coloring material,
said second area is formed of a hard resin transparent member which does not contain the laser-beam triggered coloring material, and
said laser-beam triggered coloring material is colored in a color other than black and/or a surrounding is colored in a color other than the black, upon irradiation of a laser beam used for the laser marking,

5. The transparent key according to claim 1, wherein
said color layer has said first area,
said key body has said second area,
said first area is a area which is made transparent or is discolored by the laser marking, and
said transparent key has a marking portion formed by a portion which is made transparent or is discolored by the laser marking.

6. A key sheet having the transparent key as set forth in claim 1.

7. A manufacturing method of a transparent key having a transparent key body, a color layer which is formed at a bottom surface of the key body, said color layer which is visible through said key body at a time of non-illumination, and a key base having the transparent key laid out thereon,
wherein said transparent key has a first area and a transparent second area covering the first area from a top surface side,
laser marking is easier for said first area than for said second area
said laser marking is carried out after the transparent key is laid out on said key base.
